(19) United States
(12) Patent Application Publication
(10) Pub. No.: US 2015/0363893 A1
(43) Pub. Date: Dec. 17, 2015

(54) WEB-BASED SYSTEM AND METHODS THEREOF FOR VALUE-ADDED TAX RECLAIM PROCESSING

(71) Applicant: Vatbox, Ltd., Herzliya (IL)

(72) Inventors: Isaac SAFT, Kfar Neter (IL); Noam GUZMAN, Ramat Hasharon (IL)

(73) Assignee: VATBOX, LTD., Herzliya (IL)

(21) Appl. No.: 14/836,230

(22) Filed: Aug. 26, 2015

Related U.S. Application Data
(63) Continuation of application No. PCT/IL2014/050201, filed on Feb. 27, 2014.
(60) Provisional application No. 61/769,786, filed on Feb. 27, 2013.

(51) Int. Cl. G06Q 40/00

(52) U.S. Cl. CPC G06Q 40/123

(57) ABSTRACT

A computerized method and server for authenticating and determining eligibility of a potential value-added tax (VAT) refund. The method comprises receiving a potential VAT receipt; recognizing by a server appropriate receipt parameters respective of the potential VAT receipt; determining based on the appropriate receipt parameters whether the potential VAT receipt is authentic; and determining based on the appropriate receipt parameters whether a payer is eligible for the potential VAT refund. The server comprises a processor communicatively coupled to a network; and, a memory coupled to the processor, containing a plurality of instructions that, when executed by the processor, configure the server to: receive a potential VAT receipt; recognize appropriate receipt parameters respective of the potential VAT receipt; determine based on the appropriate receipt parameters whether the potential VAT receipt is authentic; and determine based on the appropriate receipt parameters whether a payer is eligible for the potential VAT refund.

### CROSS-REFERENCE TO RELATED APPLICATIONS

This application is a continuation of PCT application No. PCT/IL2014/050201, filed on Feb. 27, 2014, which claims the benefit of U.S. provisional application No. 61/769,786 filed on Feb. 27, 2013. The contents of the above referenced applications are herein incorporated by reference.

### TECHNICAL FIELD

The invention generally relates to computerized refunding platforms, and more specifically to systems and methods for refunding of value-added taxes (VAT) to a user over the web.

### BACKGROUND

Laws and regulations of many countries allow foreign travelers the right for reimbursement or a refund of certain taxes, e.g., value-added taxes (VAT) paid for goods or services abroad. As such laws and regulations are different from one country to another, determination of the actual VAT refunds, also referred to as VAT reclaims, that one is entitled to receive often requires that the seeker of the refund possess a vast amount of knowledge in the area of tax laws abroad.

One procedure to request a refund is to physically approach a customs official at the airport, fill out a form, and file the original receipts respective of the expenses incurred during the visit. This should be performed prior to checking in or boarding for the next destination.

There are some drawbacks associated with this procedure, which does not ensure that eligible travelers will be refunded for paid VAT. For example, customs officials may not always attend their counter, the travelers do not know where the refund counter is or do not have the time to claim the refund, or the travelers are simply ignorant of the particular refund procedures in that country. In addition, many people may be intimidated or put off from claiming their refund due to the bureaucratic hurdles that must be overcome to obtain such a refund. As such, travelers and, in particular, business travelers give up on expenses that they are eligible to be reimbursed for. In particular, business travelers whose travel costs are covered by the companies they represent typically prefer not to handle the refund process, as the refund does not impact their personal finances, while the companies that they represent may have a vested interest in the refund which impacts many of their traveling employees.

VAT processing agents have certain systems for handling various aspects of a VAT reclaim process. Such systems require human intervention to resolve many of the issues of VAT receipts and determination of eligibility, and lack a full point-to-point resolution of the VAT reclaim process.

It would therefore be advantageous to provide an effective way for handling the refund of VAT electronically over the web.

### SUMMARY

A summary of several exemplary embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later. For convenience, the term some embodiments may be used herein to refer to a single embodiment or multiple embodiments of the disclosure.

Certain embodiments include a computerized method for authenticating and determining eligibility of a potential value-added tax (VAT) refund. The method comprising: receiving a potential VAT receipt; recognizing by a server appropriate receipt parameters respective of the potential VAT receipt; determining based on the appropriate receipt parameters whether the potential VAT receipt is authentic; and determining based on the appropriate receipt parameters whether a payer is eligible for the potential VAT refund.

Certain embodiments include a server for authenticating and determining eligibility of a potential value-added tax (VAT) refund. The server comprises a processor communicatively coupled to a network; and, a memory coupled to the processor, containing a plurality of instructions that, when executed by the processor, configure the server to: receive a potential VAT receipt; recognize appropriate receipt parameters respective of the potential VAT receipt; determine based on the appropriate receipt parameters whether the potential VAT receipt is authentic; and determine based on the appropriate receipt parameters whether a payer is eligible for the potential VAT refund.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic block diagram of a value-added tax (VAT) refund system operative according to one embodiment;

FIG. 2 is a flowchart describing the processing of a potential VAT refund according to one embodiment; and

FIG. 3 is a flowchart describing a process of authenticating and determining eligibility of a potential VAT refund according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

According to certain exemplary embodiments, a web-based system and methods for identifying and submitting potential value-added tax (VAT) reclaims, also referred to as VAT refunds, are disclosed. In one embodiment, a server included in the disclosed refund system is configured to analyze potential VAT reclaims related to VAT receipts provided by a user of the system. In this exemplary embodiment, a user of the system is a traveler seeking a VAT refund. The server is further configured to perform authenticity analysis for each VAT receipt as well as to determine eligibility for a VAT refund. In an embodiment, a test of refund entitlement is performed, after which the tax receipt is submitted to, for example, a refunding agency, a customs official, or the like.

According to one embodiment, the server is configured to identify a forgery or a duplicated copy of the VAT receipt respective of information stored in a database. According to another embodiment, the server may send a notification upon identification of an ineligible VAT receipt with a request for corrective actions where possible. According to yet another embodiment, the server 120 may receive a confirmation that a user has exported goods upon receiving a potential VAT receipt for the purchase of goods.

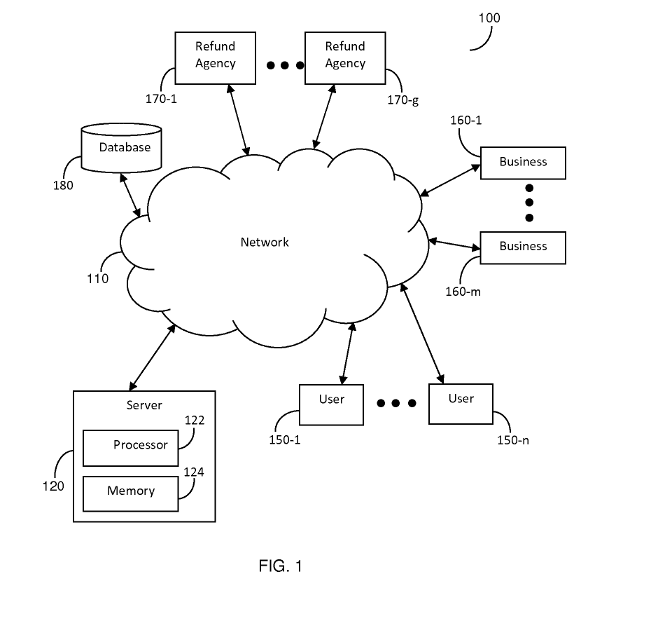

FIG. 1 shows an exemplary and non-limiting schematic diagram of a VAT refund system 100 according to one embodiment. A network 110 is coupled to several components that comprise the system 100. The network 110 can be a local area network (LAN), a wide area network (WAN), a metro area network (MAN), the worldwide web (WWW), the Internet, implemented as wired and/or wireless networks, and any combinations thereof.

A server 120 is communicatively connected to the network 110. Also connected to the network 110 are a plurality of user nodes 150, i.e., 150-1 through 150-n. It should be noted that the server 120 comprises a processing unit 122 and a memory 124. The processing unit 122 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing unit 122 may be coupled to the memory 124. In an embodiment, the memory 124 contains instructions that when executed by the processing unit 122 results in the performance of the methods and processes described herein below. Specifically, the processing unit 122 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing unit 122 to perform the various functions described herein.

According to another embodiment, the system 100 further includes one or more business nodes 160-1 through 160-m that are communicatively connected to the server 120 via the network 110. A business or a merchant operating a business node 160, for example, business node 160-1, may be, but is not limited to, a hotel, a retailer, a service provider, and the like. One or more refund agency nodes (RANs) 170-1 through 170-g, which may be hardware nodes or a software executing on a hardware, are also communicatively connected to the server 120 via the network 110. An entity operating a RAN 170, for example RAN 170-1, may be, but is not limited to, a tax authority, an accountant, and the like. Each one of the user nodes 150, the business nodes 160, and the RAN nodes 170 is a computing device, such as a personal computer (PC), a notebook computer, a cellular phone, a smartphone, a tablet device, and the like. The business node 160 may also include a point of sale terminal and the RAN node 170 may be a legacy accounting or taxation server.

The system 100 may also include a database 180 communicatively connected to the server 120. The server 120 is configured to store in the database 180 information respective of a user who submitted one or more VAT receipts, the submitted VAT receipts, and so on. The information is stored in the database 180 for further use by the server 120. The information respective of the user may include, but is not limited to, passport details, a passport photo, an electronic copy of the passport, and so on. According to one embodiment, the information stored in the database 180 is received from an external source. Such external source may be, but is not limited to, a user node 150 operated by the user, for example, user node 150-1 or a business node 160, for example business node 160-1.

When a potential VAT reclaim is identified, the server 120 performs authenticity analysis for one or more VAT receipts received respective of the information stored in the database 180. According to one embodiment, the server 120 is configured to identify a forgery or a duplicated copy of a VAT receipt. The server 120 analyzes each VAT receipt received to determine its eligibility for the VAT refund. According to one embodiment, the server 120 is configured to identify one or more missing, unclear, or otherwise unacceptable parameters in the received VAT receipt.

According to an embodiment, identification of a forgery is performed by analyzing parameters of a VAT receipt and by determining the authenticity of such parameters. The server 120 is configured to determine, for example, the authenticity of the number of a sole proprietorship, its address, and so on. The authentication may be performed by searching the database 180, or, alternatively, by verifying the information with the business/merchants 160 or with the RANs 170. For instance, the server 120 may be configured to verify that a transaction associated with a VAT receipt has been reported to the tax authorities. Additionally, the server 120 may check the authenticity of the details of an applicant as cited in the VAT receipt by searching, for example, the database 180. Hence, the server 120 may check the authenticity of a credit number and/or an account number of an applicant as provided in the VAT receipt. It should be noted that the server 120 may also check whether the VAT receipt was previously processed and stored in the database 180 to avoid erroneous or malicious duplications.

The server 120 is configured to send a request to perform corrective actions upon identification of one or more ineligible parameters within the received VAT receipt. The request may be sent to the user node 150-1 or to the business node 160-1. The server 120 is also configured to submit the VAT receipt to a RAN 170, for example RAN 170-1, upon identification of an eligible VAT receipt.

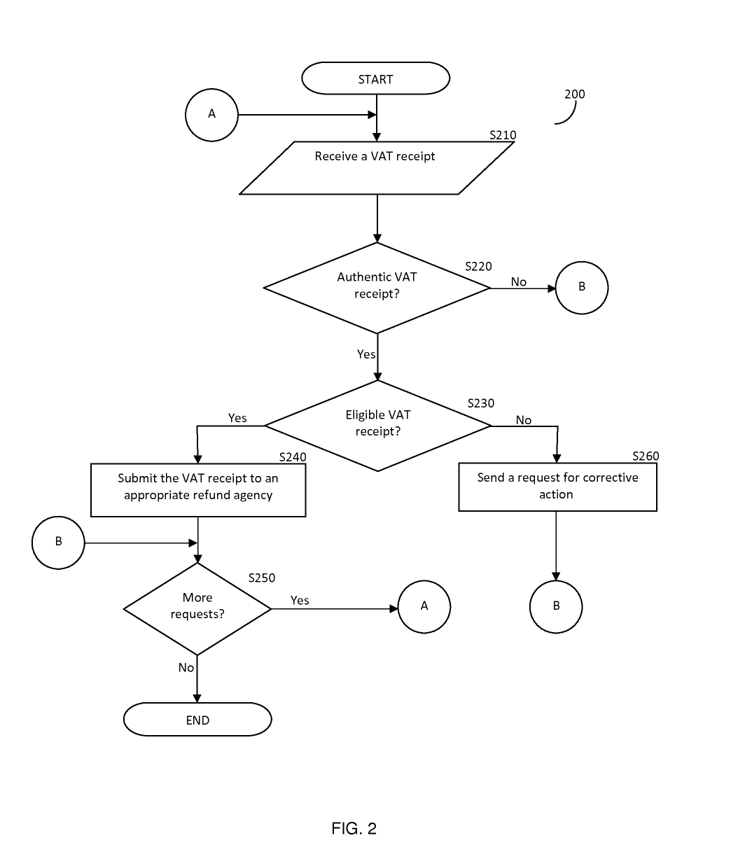

FIG. 2 depicts an exemplary and non-limiting flowchart 200 of a method for VAT reclaim processing according to one embodiment. The method may be performed by the server 120.

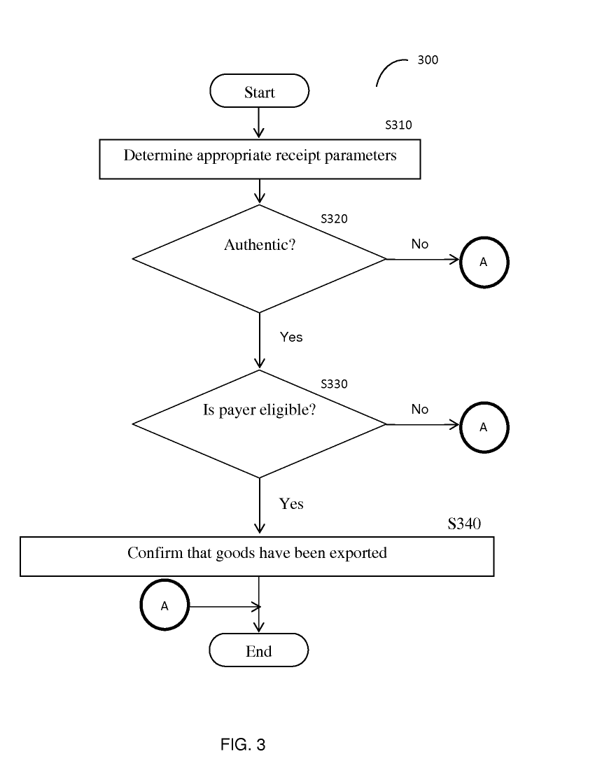

In S210, at least one VAT receipt is received. According to one embodiment, the VAT receipt may be provided by a business node 160 or, alternatively, by a user node 150, for example through a web user interface, a dedicated agent installed thereon, and the like. In S220 it is checked whether the VAT receipt is an authentic VAT receipt and, if so, execution continues with S230; otherwise, execution continues with S250. The authentication check is made respective of information stored in the database 180 by analyzing data collected from the receipt with respect to information stored in the database 180. Authentication is discussed in more detail below with respect to FIG. 3. In S230, it is checked whether the VAT receipt is an eligible VAT receipt and, if so, execution continues with S240; otherwise, execution continues with S260.

According to one embodiment, the server 120 performs an analysis of one or more parameters in the VAT receipt which are required for a VAT refund, e.g., payer's name, payer's address, name of entity being paid, tax identification of entity being paid, receipt number, description of item being paid for, date, currency, and other data appearing on a VAT receipt. Lack of the appropriate or necessary information, as well as illegibility of such information on the VAT receipt may result in a determination that the VAT is ineligible for a refund as the receipt stands. The server 120 is configured to identify one or more missing, unclear or otherwise unacceptable parameters and acting thereupon, for example, based on information in the database 180. Eligibility checking is discussed in more detail below with respect to FIG. 3.

In S240 the VAT receipt is submitted to an appropriate or otherwise preferred RAN 170. The preference may be determined based on effectiveness in getting refunds, location, and so on. In S250, it is checked whether there are additional requests and if so, execution continues with S210; otherwise, execution terminates.

In S260, a request to edit the VAT receipt may be sent to the user node 150 or the business node 160 which provided the VAT reclaim, giving an opportunity to correct and resubmit the illegible receipt. Execution continues thereafter with S250.

As an exemplary and non-limiting example of submission of a VAT receipt according to an embodiment, a user who is a traveler returning from Greece to Canada scans a receipt provided upon purchase of a souvenir and uploads the receipt to a server 120 over the network 110 via a smartphone (e.g., user node 150-1). Upon receiving the VAT receipt, the server performs authentication to ensure that the receipt is an authentic original. In this example, the receipt indicates the name and address of an existing business that is noted in a database 180 as participating in providing VAT refunds. The server 120 then compares the name and address from the receipt with the name and address data stored in the database and determines that the receipt is authentic. Next, the server 120 verifies that the receipt demonstrates a purchase that is eligible for a VAT refund by checking the price and type of item purchased, as well as the status of the customer (e.g., tourist or business traveler). Upon verifying that the consumer bought a qualified item worth above a predefined eligibility cost threshold (e.g., $30), the server submits the VAT receipt to an appropriate RAN. In this case, the server identifies a RAN associated with a refund agency that is located in Greece to be the destination for the submission. Upon confirming that no additional requests have been made, execution terminates.

As another exemplary and non-limiting example, a user who is a business traveler provides a receipt to a server 120 received pursuant to a purchase of hotel accommodations over the network 110 via a computer (e.g., user node 150-1). In the example, the receipt originally indicated a price, but the receipt has been smudged, thereby making the price illegible. The receipt also indicates the name and address of an existing business that is noted as participating in providing VAT refunds in a database 180. The server 120 compares the name and address from the receipt with the name and address data stored in the database and determines that the receipt is authentic. The server proceeds to initiate eligibility checking by comparing parameters related to price and type of purchase on the receipt to parameters stored in the database. In this case, the price is illegible. Consequently, the server 120 determines that the receipt, as is, is not eligible for a VAT refund. The server 120, acting in accordance with instructions provided in a database (e.g., database 180), sends an error message to the computer (user node 150-1) noting that the price is missing or illegible. The user is then given an opportunity to resubmit the receipt.

FIG. 3 shows an exemplary and non-limiting flowchart 300 describing a process of authenticating and determining eligibility of a potential VAT refund according to an embodiment. The method may be performed by the server 120.

In S310, in response to receiving a potential VAT receipt appropriate receipt parameters respective of the potential VAT receipt are recognized. Recognition of parameters may be performed by the server via, for example, a computer-based word recognition program or via scanning of a barcode on the receipt. In a further embodiment, parameters may be noted as absent or illegible. If parameters noted as absent or illegible are required for authentication or for eligibility checking, execution will terminate after S320 or after S330, respectively.

Such parameters may be parameters related to authentication including, but not limited to, information related to the business that sold the goods or service (e.g., the business's name, address, e-mail address, telephone number, and so on), and data related to the receipt itself (e.g., boldness of words on receipt). Such parameters may also be parameters related to eligibility including, but not limited to, payment information (e.g., payer's name, payer's address, name of entity being paid, tax identification of entity being paid, receipt number, date, currency, and other data appearing on a VAT receipt), information related to the goods or service (e.g., price, type of goods or service, description of item being paid for, and so on), and information demonstrating exportation of goods (e.g., shipping data).

In S320, it is determined based on the appropriate receipt parameters whether the potential VAT receipt is authentic. If so, execution continues with S330; otherwise, execution terminates. A potential VAT receipt may be determined to be unauthentic if it is a forgery or a duplicate. Determination of authenticity may be performed by comparing the recognized authentication parameters to information stored in a database (e.g., database 180), or by verifying the recognized authentication parameters with a business node (e.g., business node 160-1) or a RAN node (e.g., RAN 170-1). In another embodiment, if the potential VAT receipt is determined to be unauthentic, a message indicating the lack of authenticity may be generated and sent to, e.g., the user, the business, or a refund agency.

In S330, it is determined based on the appropriate receipt parameters whether the payer is eligible for a VAT refund. Determination of eligibility may be based on considerations such as: the price of the goods or services, the home country of the payer, status of the payer (e.g., business traveler, tourist, and the like), type of goods or services purchased, and so on. For example, a payer may be eligible for a VAT refund only upon purchasing $30 or more worth of goods or services from a business located in a country that is not the payer's home country. As another example, a VAT refund for hotel accommodations may only be available if the payer is a business traveler (as opposed to a tourist). Eligibility may be determined by comparing the recognized parameters with threshold eligibility parameters stored in a database (e.g., database 180). In a further exemplary embodiment, if a customer is ineligible for a VAT refund, a message indicating that the payer is ineligible may be generated and sent to the user, the business, or a refund agency via the entity's respective node. This message may further contain a request for corrective action, prompting the user or other entity to resubmit a receipt or provide additional information.

In S340, a user may be required to confirm that one or more goods has actually been exported when the refund is based on the purchase of goods. This confirmation may be completed by, e.g., the user providing a shipping receipt demonstrating that the goods have been shipped directly to another country. In a further embodiment, if a user does not successfully confirm that goods have been exported, a message indicating that the goods have not actually been exported may be generated and sent to the user, the business, or a refund agency via the entity's respective node. This message may further contain a request for corrective action.

The certain embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A person skilled-in-the-art will readily note that other embodiments may be achieved without departing from the scope of the disclosed invention. The scope of the invention should be limited solely by the claims thereto.

What is claimed is:

1. A computerized method for authenticating and determining eligibility of a potential value-added tax (VAT) refund, the method comprising:
receiving a potential VAT receipt;
recognizing by a server appropriate receipt parameters respective of the potential VAT receipt;
determining based on the appropriate receipt parameters whether the potential VAT receipt is authentic; and
determining based on the appropriate receipt parameters whether a payer is eligible for the potential VAT refund.

2. The computerized method of claim 1, wherein the server performs recognition of the appropriate receipt parameters via at least one of: a word recognition program and scanning of a barcode on the potential VAT receipt.

3. The computerized method of claim 1, wherein if the appropriate receipt parameters are not recognized executed is terminated, wherein the appropriate receipt parameters are not recognized if the appropriate receipt parameters are absent or illegible.

4. The computerized method of claim 1, wherein the appropriate receipt parameters are at least one of: information related to a business that sold a good or service on the potential VAT receipt, data related to the potential VAT receipt itself, payment information, information related to the good or service on the potential VAT receipt, and information demonstrating exportation of goods.

5. The computerized method of claim 1, wherein the potential VAT receipt is not determined to be authentic if the potential VAT receipt is a forgery or duplicate.

6. The computerized method of claim 5, wherein the determination of authenticity is performed by comparing the recognized receipt parameters to at least one of: information stored in a database, a business node, and a refund agency node (RAN).

7. The computerized method of claim 1, wherein the eligibility determination further is based on at least one of: a price of goods or services on the potential VAT receipt, a home country of the payer, status of the payer, and a type of goods or services on the potential VAT receipt.

8. The computerized method of claim 7, wherein the eligibility is determined by comparing the appropriate receipt parameters with threshold eligibility parameters stored in a database.

9. The computerized method of claim 1, further comprising:
prompting the payer to confirm that one or more goods has actually been exported when the refund is based on a purchase of goods.

10. A non-transitory computer readable medium having stored thereon instructions for causing one or more processing units to execute the method according to claim 1.

11. A server for authenticating and determining eligibility of a potential value-added tax (VAT) refund, the server comprises:
a processor communicatively coupled to a network; and,
a memory coupled to the processor, containing a plurality of instructions that, when executed by the processor, configure the server to:
receive a potential VAT receipt;
recognize appropriate receipt parameters respective of the potential VAT receipt;
determine based on the appropriate receipt parameters whether the potential VAT receipt is authentic; and
determine based on the appropriate receipt parameters whether a payer is eligible for the potential VAT refund.

12. The server of claim 11, wherein the server performs recognition of the appropriate receipt parameters via at least one of: a word recognition program, and scanning of a barcode on the potential VAT receipt.

13. The server of claim 11, wherein if the appropriate receipt parameters are not recognized execution is terminated, wherein the appropriate receipt parameters are not recognized if the appropriate receipt parameters are absent or illegible.

14. The server of claim 11, wherein the appropriate receipt parameters are at least one of: information related to a business that sold a good or service on the potential VAT receipt, data related to the potential VAT receipt itself, payment information, information related to the good or service on the potential VAT receipt, and information demonstrating exportation of goods.

15. The server of claim 11, wherein the potential VAT receipt is not determined to be authentic if the potential VAT receipt is a forgery or duplicate.

16. The server of claim 15, wherein the determination of authenticity is performed by comparing the recognized receipt parameters to at least one of: information stored in a database, a business node, and a refund agency node (RAN).

17. The server of claim 11, wherein the eligibility determination further is based on at least one of: a price of goods or services on the potential VAT receipt, a home country of the payer, status of the payer, and a type of goods or services on the potential VAT receipt.

18. The server of claim 17, wherein the eligibility is determined by comparing the appropriate receipt parameters with threshold eligibility parameters stored in a database.

19. The server of claim 11, wherein the server is further configured to:
prompt the payer to confirm that one or more goods has actually been exported when the refund is based on a purchase of goods.
